(19) United States
(12) Patent Application Publication
(10) Pub. No.: US 2004/0128485 A1
(43) Pub. Date: Jul. 1, 2004

(54) Method for fusing instructions in a vector processor

(76) Inventor: Scott R. Nelson, Pleasanton, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/330,841

(22) Filed: Dec. 27, 2002

(51) Int. Cl. G06F 15/00

(52) U.S. Cl. 712/218; 712/4

(57) ABSTRACT

According to one embodiment, a microprocessor is described. The microprocessor includes a scalar processor and a vector processor. The vector processor fuses multiple instructions that are to be processed. The fused instructions enable a single source register to simultaneously transmit its data contents to multiple math units.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The present invention relates to computer systems; more particularly, the present invention relates to vector processors.

### BACKGROUND

Since the advent of personal computers (PCs), there have been continuous efforts to provide for increased PC performance. The major factor of increased PC performance is the speed of the PC's microprocessor. In conventional PCs superscalar microprocessors are implemented. Superscalar processor architectures enable more than one instruction to be executed per clock cycle. Superscalar processors include various function units with one or more registers coupled to each function unit.

Vector processors may also be implemented in a PC. Vector processors provide high-level operations that work on vectors (e.g., linear arrays of numbers). A vector processor includes a multitude of registers and function units. For example, FIG. 5 illustrates a typical vector processor. The vector processor illustrated in FIG. 5 includes five vector registers, and multiplier and adder function units. When implementing an operation at a function unit, operands are received at a function unit from two registers and the result is stored in a third register. For example, in an operation A*B+C, the operand A is received at the multiplier from a first storage element of register 1, the operand B is received from a first storage element of register 2 and the result (e.g., A*B) is stored in a first storage element of register 3 three to four clock cycles after the operands are received at the multiplier. To complete the operation, the operand A*B is received from the first storage element of register 3 at the adder, the operand C is received from a first storage element of register 4. The result (e.g., A*B+C) is stored in a first storage element of register 5 three to four clock cycles after the operands are received at the adder.

The problem with typical vector processors is that in order to complete the second half of the operation (e.g., adding C to A*B), the second function unit must wait until the result of the first half of the operation (e.g., three-four clock cycles) is stored in register 3. Having to wait on the first half of the computation may result in a significant time delay, therefore affecting the performance of the processor and PC.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 is a block diagram of one embodiment of a computer system;

FIG. 2 is a block diagram of one embodiment of a processor:

FIG. 3 is a block diagram of one embodiment of a vector processor core:

FIG. 4 is a block diagram of another embodiment of a vector processor core; and

FIG. 5 illustrates a typical vector processor.

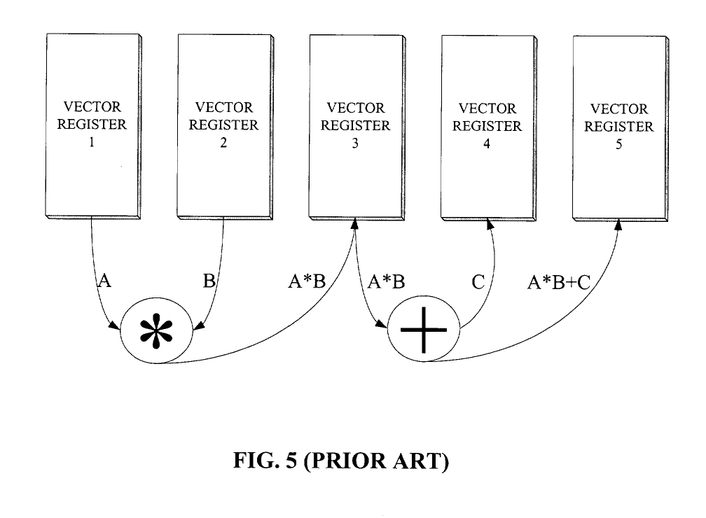

### DETAILED DESCRIPTION

A method for instructions in a vector processor is described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

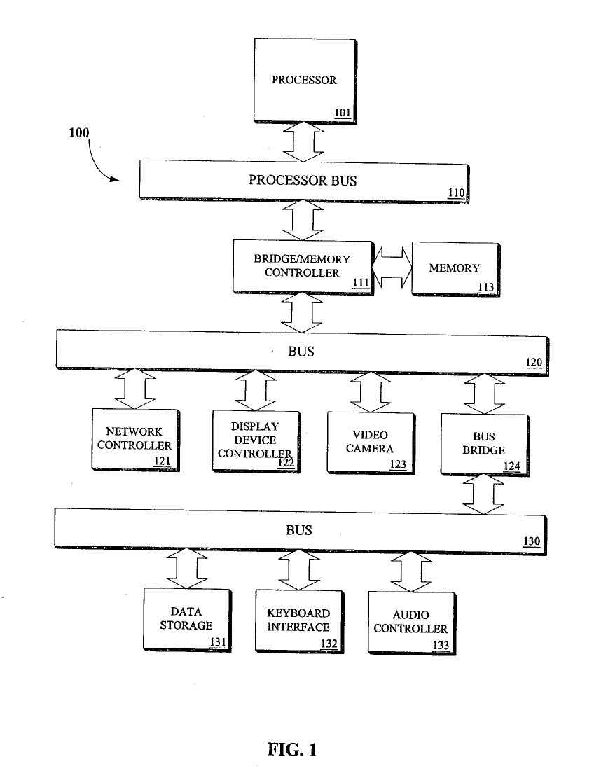

FIG. 1 is a block diagram of one embodiment of a computer system 100. Computer system 100 includes a processor 101. Processor 101 is coupled to a processor bus 110. Processor bus 110 transmits data signals between processor 101 and other components in computer system 200. Computer system 100 also includes a memory 113. In one embodiment, memory 113 is a dynamic random access memory (DRAM) device. However, in other embodiments, memory 113 may be a static random access memory (SRAM) device, or other memory device. Memory 113 may store instructions and code represented by data signals that may be executed by processor 101.

Computer system 100 further includes a bridge memory controller 111 coupled to processor bus 110 and memory 113. Bridge/memory controller 111 directs data signals between processor 101, memory 113, and other components in computer system 100 and bridges the data signals between processor bus 110, memory 113, and a first input/output (I/O) bus 120. In one embodiment, I/O bus 120 may be a single bus or a combination of multiple buses.

In a further embodiment, I/O bus 120 may be a Peripheral Component Interconnect adhering to a Specification Revision 2.1 bus developed by the PCI Special Interest Group of Portland, Oreg. In another embodiment, I/O bus 120 may be a Personal Computer Memory Card International Association (PCMCIA) bus developed by the PCMCIA of San Jose, Calif. Alternatively, other busses may be used to implement I/O bus. I/O bus 120 provides communication links between components in computer system 100.

A network controller 121 is coupled I/O bus 120. Network controller 121 links computer system 200 to a network of computers (not shown in FIG. 1) and supports communication among the machines. A display device controller 122 is also coupled to I/O bus 120. Display device controller 122 allows coupling of a display device to computer system 100, and acts as an interface between the display device and computer system 100. In one embodiment, display device controller 122 is a monochrome display adapter (MDA) card. In other embodiments, display device controller 122 may be a color graphics adapter (CGA) card, an enhanced graphics adapter (EGA) card, an extended graphics array (XGA) card or other display device controller.

The display device may be a television set, a computer monitor, a flat panel display or other display device. The display device receives data signals from processor 101 through display device controller 122 and displays the information and data signals to the user of computer system 100. A video camera 123 is also coupled to I/O bus 120.

Computer system 100 includes a second I/O bus 130 coupled to I/O bus 120 via a bus bridge 124. Bus bridge 124 operates to buffer and bridge data signals between I/O bus 120 and I/O bus 130. I/O bus 130 may be a single bus or a combination of multiple buses. In one embodiment, I/O bus 130 is an Industry Standard Architecture (ISA) Specification Revision 1.0a bus developed by International Business Machines of Armonk, N.Y. However, other bus standards may also be used, for example Extended Industry Standard Architecture (EISA) Specification Revision 3.12 developed by Compaq Computer, et al.

I/O bus 130 provides communication links between components in computer system 100. A data storage device 131 is coupled to I/O bus 130. I/O device 131 may be a hard disk drive, a floppy disk drive, a CD-ROM device, a flash memory device or other mass storage device. A keyboard interface 132 is also coupled to I/O bus 130. Keyboard interface 132 may be a keyboard controller or other keyboard interface. In addition, keyboard interface 132 may be a dedicated device or can reside in another device such as a bus controller or other controller. Keyboard interface 132 allows coupling of a keyboard to computer system 100 and transmits data signals from the keyboard to computer system 100. An audio controller is also coupled to I/O bus 130. Audio controller 133 operates to coordinate the recording and playing of sounds.

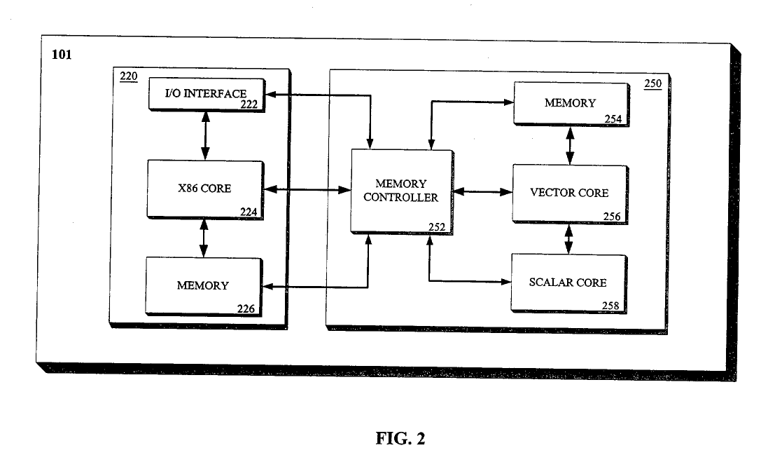

FIG. 2 is a block diagram of one embodiment of a processor 101. Processor 101 includes an IA-32 architecture processor 220, developed by Intel Corporation of Santa Clara, Calif., and a vector processor 250. In one embodiment, IA-32 processor 220 is a processor in the Pentium® family of processors including the Pentium® II processor family and Pentium® III processors available from Intel. However, one of ordinary skill in the art will appreciate that processor 220 may be implemented using other manufacturer processors.

Processor 220 includes an input/output (I/O) interface 222, a processor core 224 and a memory 226. I/O interface 222 interfaces processor 220 with I/O devices coupled to computer system 100. Processor core 224 processes data signals received at processor 220. Processor 200 may be a complex instruction set computer (CISC) microprocessor, a reduced instruction set computing (RISC) microprocessor, a very long instruction word (VLIW) microprocessor, a processor implementing a combination of instruction sets, or other processor device. Memory 226 stores data signals that are executed by core 224. According to one embodiment, memory 226 is a cache memory that stores data signals that are also stored in memory 113. Memory 226 speeds up memory accesses by core 224 by taking advantage of its locality of access. In another embodiment, memory 226 resides external to processor 220.

Vector processor 250 includes a memory controller 252, a memory 254, a vector processing core 256 and a scalar processing core 258. Memory controller 252 controls memory 226 and memory 254. In particular, memory controller 252 controls memory reads and writes to memory 226 and to memory 254. Memory controller 252 can read or write a vector register within vector core 256 independently of other units in vector core 256, as long as there are no resource conflicts.

Memory 254 is a high-speed memory designed for parallel access by both the vector core 256 and memory controller 252. In one embodiment, memory 254 is a 4-port memory allowing four simultaneous reads, four simultaneous writes, or any combination of the two. In a further embodiment memory 254 is a 128 KByte DRAM having 16 banks of 32-bit wide memory, each with 2048 locations. The banks may be interleaved such that 16 sequential words would be stored as one word in each bank.

Scalar core 258 sets up instructions so that vector core 256 can operate. In one embodiment, scalar core 258 feeds vector instructions to a vector instruction queue (not shown) within vector core 256. For example, scalar core 258 distributes program control, conditional branches, and function calls. In a further embodiment, scalar processor 258 processes one 32-bit operation per cycle.

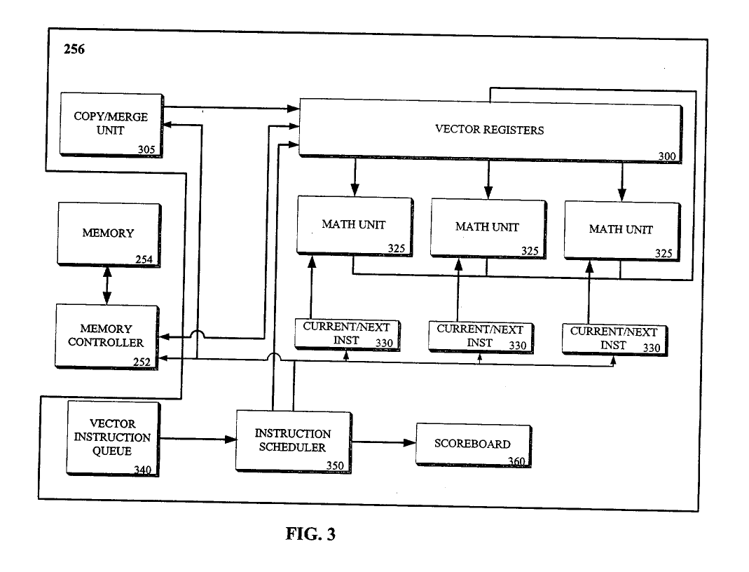

Vector core 256 performs vector operations on an internal vector register (not shown). For example, a vector operation such as a multiply instruction, multiplies each of a plurality of elements within two vector registers, storing each result in a third vector register. In one embodiment, the same operation is performed every cycle. FIG. 3 is a block diagram of one embodiment of vector core 256. Vector core 256 includes vector registers 300.

Vector registers 300 are used to implement mathematical operations within core 256. In one embodiment, there are 16 vector registers within vector registers 300. In a further embodiment, each register holds 256 32-bit elements. Each vector register is implemented as two banks of single-ported memory, interleaved as even and odd addresses, for a total of 32 memory banks to implement the 16 vector registers. In this embodiment, simultaneous reads and writes may occur in opposite banks. In yet another embodiment, vector registers 300 include a vector length register that specifies the number of words to be processed.

Vector core 256 also includes a copy/merge unit 305. Copy/merge unit 305 controls copying of data between one vector register and another. According to one embodiment, copy/merge unit 305 runs independently of other units in the vector processor. Vector core 256 further includes math units 325. Math units 325 perform arithmetic and logical operations within processor core 256. In one embodiment, each math unit 325 includes multiple math processors working in parallel in a Single Instruction Multiple Data (SIMD) stream.

In a further embodiment, math units 325 operate as one logical math unit. In another embodiment, each math unit 325 includes an integrated accumulator. The accumulators are used when vectors are summed (e.g., for multiply/accumulate instructions, and for maximum and minimum operations). The final result of all accumulator instructions is stored back into one or two scalar registers within scalar core 258. Further, each math unit has an associated current/next instruction queue 330. The current/next instruction queues 330 holds the current instruction being executed at a math unit 325 and the next instruction to be executed.

Vector core 256 also includes a vector instruction queue 340. Vector instruction queue 340 receives vector instructions from scalar core 258. In one embodiment, queue 340 holds up to 16 instructions, which allows scalar core 258 to get ahead of vector core 256. As resources become available (e.g., math units, registers, and so on), instructions are pulled from the queue 340 and sent to the appropriate math unit 325 for processing.

Vector core 258 also includes an instruction scheduler 350. Scheduler 350 retrieves instructions from queue 340 and transmits the instructions to a math unit 325, a copy/merge unit 305, or memory controller 252 as appropriate. According to one embodiment, scheduler 350 monitors each current/next instruction queue 330 to determine if a queue 330 is free to accept a new instruction. If a queue 330 is ready to accept a new instruction, scheduler 350 determines if all of the resources required to execute the next instruction in the instruction queue 340 are available. If so, the instruction is transmitted to a math unit 325 for processing. If sufficient resources are not available, the instruction is held in instruction queue 340 until resources become available.

Vector core 256 includes scoreboard 360 that keeps track of which resources are in use. By keeping track of the vector core 256 resources, scoreboard 360 enables instruction scheduler 350 to efficiently and safely schedule instructions. Resources tracked by the scoreboard include vector registers 300 (e.g., one read and one write for each), math units 325, memory controller 252 ports, and copy/merge unit 305. In one embodiment, to properly allocate vector registers 300, and avoid conflicts, a simple scoreboarding technique is used.

Each vector register 300 has two pointers, one pointer to indicate from which register element that data is being read, and one pointer to indicate to which register element that data is being written. The read or write paths to each register 300 are free before an instruction may be scheduled that uses it. For simultaneous read and write accesses to one vector register 300, vector register 300 pointer logic guarantees that the read pointer cannot pass the write pointer in read after write scenarios; or that the write pointer cannot pass the read pointer in write after read scenarios. The vector register pointer logic makes chaining available to all vector instructions.

Chaining enables a vector instruction that reads a vector register 300 currently being written to by another vector instruction to be chained to the previous instruction, using a result as soon as it is available rather than waiting for all elements of the vector register to be written. Chaining greatly reduces the latency of dependent instructions and simplifies the task of keeping all math units 325 busy as much of the time as possible. It may also be used for memory instructions coordinated with computation instructions.

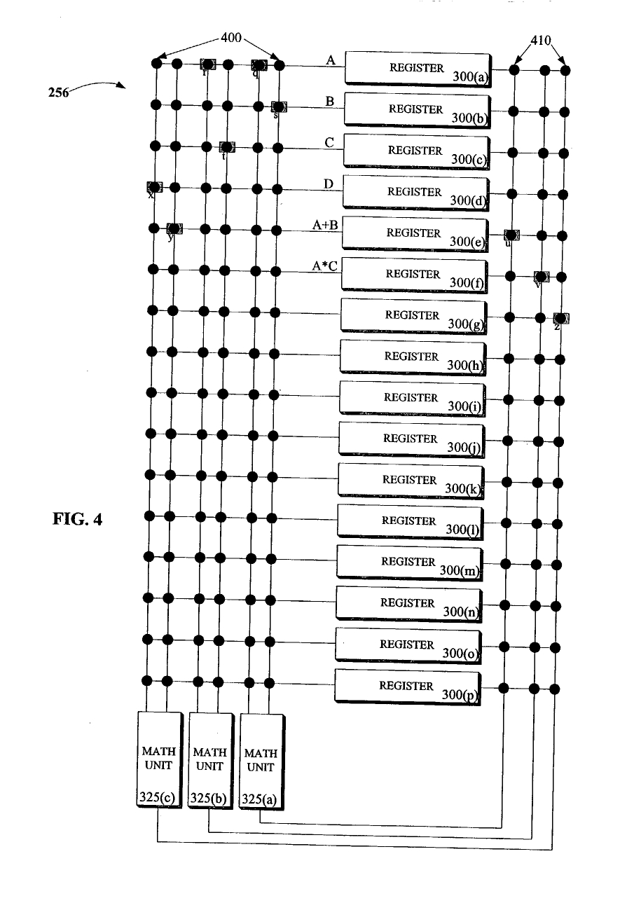

According to one embodiment, vector core 256 implements fused instructions. FIG. 4 is a block diagram of one embodiment of processor core 256 implementing fused instructions. Fused instructions enable a single source register to simultaneously transmit its contents to multiple math units. Thus, In embodiment, each vector register 300 is coupled to each math unit 325 via a cross-bar switch 400 and a cross-bar switch 410. A cross-bar switch is a device that is capable of channeling data between any two devices (e.g., register 300 and math unit 325) that are attached to the cross-bar switch, up to the switch's maximum number of connection ports. The paths set up between the devices can be fixed for some duration or changed when desired and each device-to-device path (going through the switch) is usually fixed for some period.

Cross-bar switch 400 channels data from vector registers 300 and math units 325. In particular, cross-bar switch 400 enables any of the vector registers 300 to simultaneously transmit data to multiple math units 325. Conversely, cross-bar switch 410 channels data from math units 325 back to vector registers 300 ,and cross-bar switch 410 enables any of the math units 325 to simultaneously transmit data to multiple vector registers 300. Thus, cross-bar switches 400 and 410 enable [Fusing of instructions by allowing?] each register 300 to share a single path to and from each math unit 325.

Fused instructions facilitate the combining of multiple instructions that share common register 300 sources. Data is combined, synchronized and simultaneously transmitted from vector registers 300 to math units 325 via cross-bar switch 400. Connection ports of cross-bar switch 400 select, under the control of scheduler 350, which data is transmitted to which math unit 325.

In one embodiment, scheduler 350 detects that an instruction can be fused with another instruction with the same source vector register 300. As a result, scheduler determines which math units 325 are to execute the instructions, and with the assistance of scoreboard 360, determines if those math units 325 are available. In a further embodiment, scheduler 350 delays the start of a vector operation as necessary so that the instructions may be aligned for transmission. Consequently, the fused data is synchronously transmitted to math units 325.

As an example, scheduler 350 may determine that a first instruction (A+B) and a second instruction (A*C) are to be executed. Scheduler 350 recognizes that operands A, B and C are stored in vector registers 300(a)-300(c), respectively. Accordingly, scheduler 350 schedules the first instruction to be executed at math unit 325(a) and the second instruction to be executed at math unit 325(b). As described above, scheduler 350 may delay the data corresponding to one of the instructions so that the other may be transmitted simultaneously.

As the data is transmitted, scheduler 350 instructs cross-bar switch 400 connections in the data paths to select a corresponding operand from a vector register 300. For instance, cross-bar switch connections 400(q) and 400(r) select operand A to be transmitted to math units 325(a) and 325(b), respectively. Similarly, cross-bar switch connection 400(s) selects operand B to be transmitted to math unit 325(a), while cross-bar switch connections 400(t) selects operand C to be transmitted to math unit 325(b).

According to one embodiment, math unit 325 takes up to eight clock cycles to execute the received data. After the math units execute the instructions, the results are transmitted to registers 300 for storage via cross-bar switch 410. For example, cross-bar switch connection 400(u), under the direction of scheduler 350, selects the output of math unit 325(a) for storage at register 300(e). Likewise, cross-bar switch connection 400(v) selects the output of math unit 325(b) for storage at register 300(f).

According to a further embodiment, the chaining process described above enables a result stored in a vector register 300 to be available for transmission to a math unit 325 one-clock cycle after the result has been stored. For instance, the value of the first instruction (A+B) may be utilized in a third instruction ((A+B)*D) one clock cycle after the first instruction has been stored at register 300(e). Consequently, cross-bar switch 400(x) selects operand D from register 300(d) and cross-bar switch connection 400(y) selects operand A+B to be transmitted to math unit 325(c).

After math unit 325(c) executes the instruction, the result is transmitted to register 300(g) for storage via cross-bar switch connection 400(z). In conventional vector processors, it is necessary to complete an entire instruction throughout each element of a register prior to beginning the next instruction at the register. Having to wait for each computation to be stored in a register may result in a time delay muc more significant than one clock cycle.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

Thus, a method of executing operands in a vector processor has been described.

What is claimed is:

1. A microprocessor comprising:
a scalar processor; and
a vector processor that fuses multiple instructions that are to be processed.

2. The microprocessor of claim 1 wherein the vector processor comprises:
a scalar processing core; and
a vector processing core.

3. The microprocessor of claim 2 wherein the scalar processing core provides vector instructions to the vector processing core.

4. The microprocessor of claim 3 wherein the vector processing core comprises:
a plurality of vector registers;
a first cross-bar switch coupled to the plurality of vector registers; and
a plurality of math units coupled to the first cross-bar switch.

5. The microprocessor of claim 4 wherein the vector processing core further comprises a second cross-bar switch coupled to the plurality of math units and the plurality of registers.

6. The microprocessor of claim 4 wherein the vector processing core fuses instructions via the first cross-bar switch to enable a vector register to simultaneously transmit to multiple math units.

7. The microprocessor of claim 4 wherein the vector processing core further comprises:
a vector instruction queue;
an instruction scheduler, coupled to the vector instruction queue and the vector registers, that determines which math units are to execute instructions; and
a scoreboard coupled to the instruction scheduler.

8. A computer system comprising:
a memory;
a memory controller coupled to the memory; and
a microprocessor, coupled to the memory controller, that includes:
a scalar processor; and
a vector processor that fuses multiple instructions that are to be processed.

9. The computer system of claim 8 wherein the vector processor comprises:
a scalar processing core; and
a vector processing core.

10. The computer system of claim 9 wherein the scalar processing core provides vector instructions to the vector processing core.

11. The computer system of claim 10 wherein the vector processing core comprises:
a plurality of vector registers coupled to the memory controller;
a first cross-bar switch coupled to the plurality of vector registers; and
a plurality of math units coupled to the first cross-bar switch.

12. The computer system of claim 11 wherein the vector processing core further comprises a second cross-bar switch coupled to the plurality of math units and the plurality of registers.

13. The computer system of claim 11 wherein the vector processing core fuses instructions via the first cross-bar switch to enable a vector register to simultaneously transmit to multiple math units.

14. The computer system of claim 11 wherein the vector processing core further comprises:
a vector instruction queue;
an instruction scheduler, coupled to the vector instruction queue and the vector registers, that determines which math units are to execute instructions; and
a scoreboard coupled to the instruction scheduler.

15. A method comprising:
scheduling a first instruction to be executed at a first math unit;
scheduling a second instruction to be executed at a second math unit; and
fusing data from a first register to the first math unit and the second math unit in order to execute the first instruction and the second instruction.

16. The method of claim 15 further comprising:
executing the first instruction at the first math unit; and
executing the second instruction at the second math unit;

17. The method of claim 15 further comprising fusing data from a second register to the first math unit and the second math unit in order to execute the first instruction and the second instruction.

18. The method of claim 16 further comprising delaying data corresponding to the first instruction so that the data corresponding to the first instruction can be transmitted simultaneously with corresponding to a second instruction.
